(19) United States
(12) Patent Application Publication
(10) Pub. No.: US 2022/0106095 A1
(43) Pub. Date: Apr. 7, 2022

(54) REUSABLE ENVIRONMENTALLY SUSTAINABLE BAG

(71) Applicant: BRINGiT Bags PBC, Inc., Menlo Park, CA (US)

(72) Inventor: Michelle Ivankovic, Amsterdam (NL)

(21) Appl. No.: 17/492,035

(22) Filed: Oct. 1, 2021

Related U.S. Application Data
(60) Provisional application No. 63/086,320, filed on Oct. 1, 2020.

(51) Int. Cl. B65D 65/46; B65D 30/00; B65D 33/06; B65D 33/00

(52) U.S. Cl. CPC B65D 65/466; B65D 33/002; B65D 33/065; B65D 29/00

(57) ABSTRACT

Reusable shopping or produce bags are made from a fabric material. The fabric material may be woven or non-woven. The bags may be used with existing grocery store fixtures. For example, a reusable shopping bag can be designed to hang on existing checkout fixtures designed for conventional plastic shopping bags. Similarly, a roll of produce bags can be dispensed from an existing fixture designed for conventional plastic produce bags. Thus, the bags may be used in grocery stores with little to no reconfiguration of existing check outs and product display areas.

### CROSS-REFERENCE TO RELATED APPLICATIONS

This application claims the benefit of U.S. Provisional Patent Application No. 63/086,320, entitled “Reusable Environmentally Sustainable Bag,” filed on Oct. 1, 2020, which is incorporated by reference.

### BACKGROUND

### 1. Technical Field

The subject matter described relates generally to bags and, in particular, to environmentally sustainable alternatives to plastic bags used in grocery stores.

### 2. Background Information

Concern about the environmental impact of plastic grocery shopping bags is widespread. Many cities and states have now banned their use over environmental concerns. However, the available alternatives are less than ideal. For example, reusable cotton shopping bags are a popular choice, but cotton farming requires a large amount of land, water, and other resources. Some studies suggest that cotton bags need to be reused thousands of times to realize meaningful environmental benefits over plastic. Another option is paper grocery bags, but these are generally considered less convenient by customers. Furthermore, comparing the environmental impact of paper and plastic bags is tricky due to the large number of variables involved.

Grocery bags are also not the only type of plastic bag found in typical grocery stores. Each year in the United States alone, approximately sixty-six billion single-use plastic produce bags are used and discarded. For every grocery shopping trip, an average of two to three produce bags are used. The produce bag problem is hidden in plain sight. People do not consider plastic produce bags to be a problem to the extent that they do with single-use plastic grocery shopping bags.

### SUMMARY

Reusable shopping or produce bags are made from a fabric material. The fabric material may be woven or non-woven. In various embodiments, the bags may be used with existing grocery store fixtures. For example, a reusable shopping bag can be designed to hang on existing checkout fixtures designed for conventional plastic shopping bags. Similarly, a roll of produce bags can be dispensed from an existing fixture designed for conventional plastic produce bags. Thus, the bags may be used in grocery stores with little to no reconfiguration of existing check outs and product display areas.

An embodiment of a shopping bag has a body and a pair of handles at the top of the body. The handles are located on either side of an opening into the interior of the bag. Each handle has a slit (or other type of hole) through it. The slits are spaced such that the bag may be hung on a checkout fixture by placing the left and right prongs of the fixture through the left and right slit or hole, respectively. The bag may also include a tab in approximately the center of the top edge of the body. The tab includes a hole or slit positioned such that a central prong of the checkout fixture may pass through it when the bag is hung on the fixture. Some or all of the body, handles, and tab may be made from a wood-based compostable material.

An embodiment of a produce bag has a body with a top end and a bottom end. The top end is at least partially open to enable produce to be placed inside while the bottom end is closed. The body may be made from a wood-based compostable material. A top connector is attached to the top end of the body and a bottom connector is attached to the bottom end of the body. The top connector is configured to engage with the bottom connector of the next bag in a roll while the bottom connector is configured to engage with the top connector of the previous bag in the roll. For example, the top and bottom connectors may include a tab and slot that form an interference connection. Alternatively, adjacent bags in a roll may be connected connection points made from a material that tears more easily than the body of the bags to enable convenient separation of the bags.

### BRIEF DESCRIPTION OF THE DRAWINGS

FIG. 1 is a technical drawing of a first embodiment of a shopping bag.

FIG. 2 is perspective view of the first embodiment of the shopping bag.

FIG. 3 is a technical drawing of a second embodiment of the shopping bag.

FIG. 4 is a perspective view of a roll of produce bags, according to one embodiment.

FIG. 5 illustrates a first embodiment of the produce bags.

FIG. 6 illustrates a second embodiment of the produce bags.

### DETAILED DESCRIPTION

The figures and the following description describe certain embodiments by way of illustration only. One skilled in the art will readily recognize from the following description that alternative embodiments of the structures and methods may be employed without departing from the principles described. Wherever practicable, similar or like reference numbers are used in the figures to indicate similar or like functionality. Where elements share a common numeral followed by a different letter, this indicates the elements are similar or identical. A reference to the numeral alone generally refers to any one or any combination of such elements, unless the context indicates otherwise.

### Example Shopping Bags

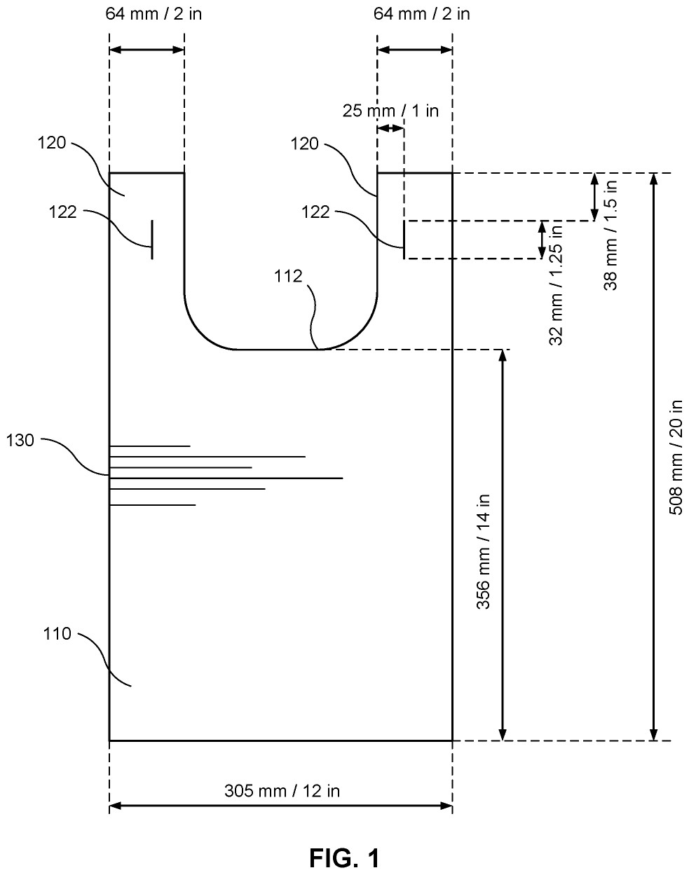

FIG. 1 illustrates a first embodiment of a shopping bag. In the embodiment shown, the shopping bag has a body 110 and a pair of handles 120. An opening 112 enables objects (e.g., groceries) to be placed inside the body 112 and each handle has a slit 122 passing through the handle. In other embodiments, the shopping bag includes different or additional elements. In addition, the elements may have different geometries or configurations. For example, although the handles 120 are described as having slits 122, these may be replaced by holes with other geometries. Note that although FIG. 1 provides specific dimensions for the bag for illustrative purposes, a wide range of shapes and sizes of bag that are consistent with the disclosed principles are possible.

The body 110 is made from a woven or knitted fabric. The fabric may be a compostable wood-based fabric. In the embodiment shown, the body 110 is formed from a knitted fabric with the knit ribs 130 running horizontally across the body. This may enable the body 110 to have flexibility in the vertical direction such that it may stretch to accommodate a greater volume of items. Alternatively, the knit ribs 130 may run vertically. This may still allow some amount of stretch to increase the volume within the bag while preventing the bag from stretching vertically to an inconvenient extent. For example, it is inconvenient for a shopper if their loaded shopping bag stretches vertically to the extent that it drags along the floor when carried at a typical height.

The body 110 may be formed from two substantially identical pieces (a front piece and a back piece) that are connected (e.g., stitched, glued, or fused) around the periphery. In particular, the left, right, and bottom edges of the to pieces may be connected while some or all of the top edges remain unconnected. If the pieces are stitched together, the stitching of one or more sides may end with a reverse stitch to provide reinforcement. Regardless of precisely how the edges are joined, they define an opening 112 through which objects can be placed into and taken out of the bag.

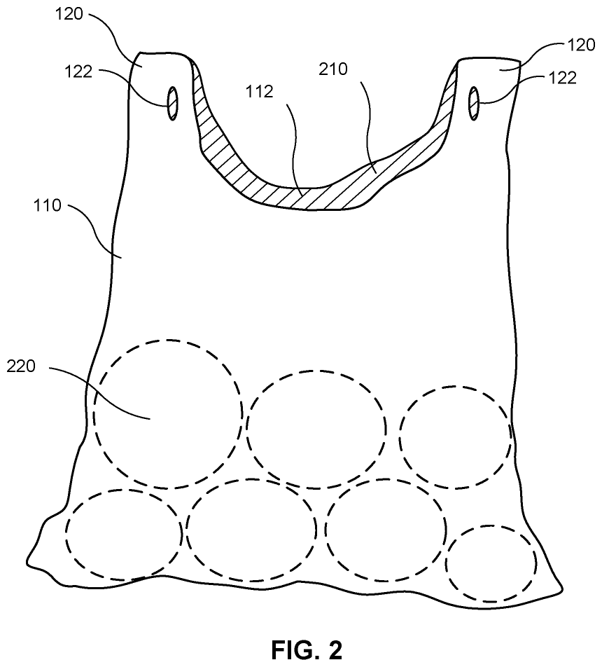

FIG. 2 is perspective view of the first embodiment of the shopping bag. A set of objects 220 (e.g., groceries) have been placed inside the bag through the opening 112. Because the bag is slightly open, the interior surface 210 of the back piece of the body 110 can be seen. The interior surfaces 210 of the front and back pieces define the internal volume of the bag in which the objects 220 are located.

The handles 120 are located at the top edge of the body 110. In the embodiment shown, the handles are formed by portions of the front and back pieces of the body, connected at the top edge of the handles. However, the handles 120 may also be distinct pieces, connected (e.g., sown, glued, or fused) to the top edge of the body 110. Each handle 120 has a slit 122 or other hole passing through it. The slits 122 passes through both the front and back portions of the handles 112. In other words, the portions of a handle 120 formed by the front and back pieces of the body may each contain a slit that is aligned with the corresponding slit on the other piece of the body. In the embodiment shown, the slits 122 are separated by approximately by the same distance as the left and right prongs of a typical shopping bag fixture at a grocery store checkout. Thus, the bag may be hung on existing fixtures designed for plastic shopping bags.

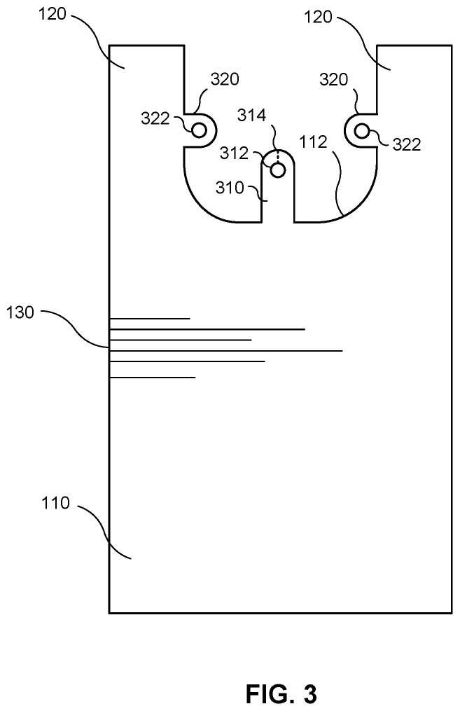

FIG. 3 illustrates a second embodiment of the shopping bag. The embodiment shown is similar to the bag shown in FIGS. 1 and 2, having a body 110 and a pair of handles 120. Instead of slits 122 near the center of the handles 120, the handles have side tabs 320 that include holes 322. The side tabs 320 may be fused or otherwise affixed to the handles 320 (e.g., using mechanical interference, chemical bonding, etc.). Alternatively, a side tab 320 and a grip portion of the handle 120 designed to be held may be formed from a single piece of material (e.g., being formed from a front or back piece of the body 110). As shown, the bag has left and right tabs 320 connected to the left and right handles 120, respectively. In some embodiments, the bag includes front and back side tabs 320 connected to the front and back pieces of the body 110, respectively. The holes 322 in the front and back side tabs 320 align with each other.

The bag also has a central tab 310 connected to the body 110 at roughly the center point of the body's top edge. The central tab 310 may be affixed to the top edge of the front or back piece of the body 110 or be part of the front or back piece of the body. The central tab 310 includes a hole 312 positioned to have a central prong of a typical shopping bag fixture pass through it when the left and right prongs of the fixture are passing through the holes 322 in the tabs 320.

The central tab 310 may have a perforated tear line 314 running from the hole 312 to an exterior edge of the central tab to enable it to be easily torn off the central prong of the fixture. Furthermore, the bag may include a second central tab on the other side of the bag to the central tab 310 (i.e., the front and back pieces of the body 110 that define the opening 112 may each have central tabs having holes that align with each other).

The side tabs 320 on the handles 120 and/or the central tab 310 may be reinforced with a glue-like material to reduce the likelihood of the bag being unintentionally torn from a bag-holding fixture. In one embodiment, instead of a perforated tear line 314, a slit is cut in the fabric of the central tab 310 from the hole 312 to an exterior edge. The slit is initially fused closed with a glue-like material that enables the third tab to be torn from a fixture by reopening the slit with less force than is required to tear the bag fabric.

In further embodiments, different combinations of tabs and slits (or other holes) in the bag may be used. For example, the handles 120 may include slits 122 while a central tab 310 may be connected to the top edge of the front or back pieces of the body 110. The slits 122 may be reinforced with a glue-like material, a second layer of fabric, or other strengthening elements disposed around the periphery of the slits.

As described previously, in various embodiments, the bag is formed at least in part from a wood-based fabric. One example of such a fabric is LENSING™, which is made from beechwood. Because beech trees naturally propagate themselves, beechwood can be obtained sustainably by periodically thinning out the forest without the need for reforestation. Thus, this fabric can be produced in a naturally sustainable manner. Furthermore, it can be durable (e.g., holding up to twenty-two pounds over 125 yards without ripping), lightweight (e.g., one ounce per bag), machine washable, and printed with designs (e.g., using carbon-neutral dyes). Furthermore, the material is biodegradable and can be home-composted.

### Example Produce Bags

The same or similar materials as those described above for shopping bags may also be used to make produce bags that can be used with existing grocery store fixtures. The material may be a woven or knitted mesh so that items inside may be seen and identified without opening the bag.

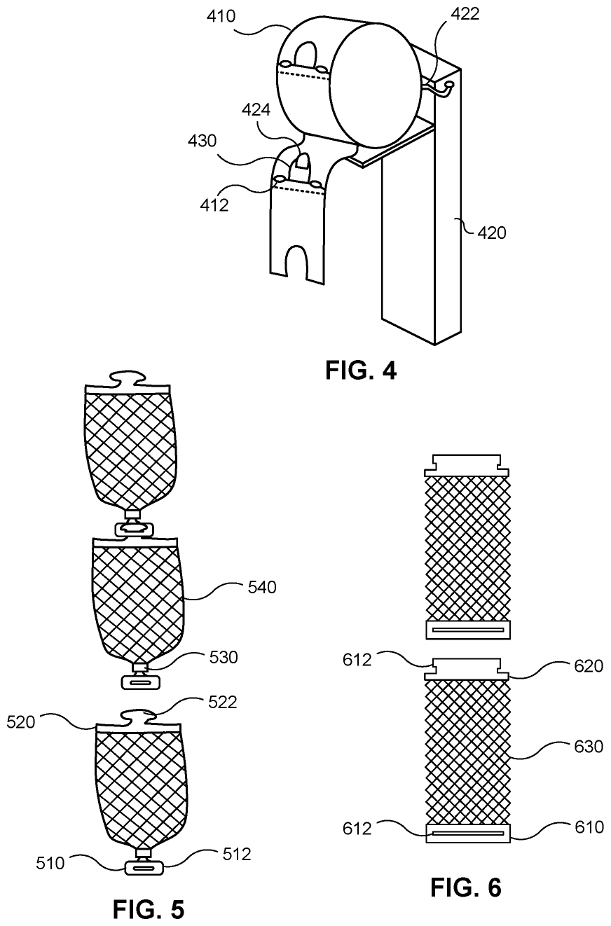

FIG. 4 illustrates a roll of produce bags 410 mounted on a fixture 420, according to on embodiment. The fixture includes a rod 422 around which the role 410 rotates and a hook 424 configured to pass through a hole 430 defined by the top edge of one bag and the bottom edge of the adjacent badge. The fixture 420 may be of a type that is already installed in grocery stores for plastic produce bags. Thus, the produce bags 410 made from fabric may be used with existing fixtures 410 without the need for substantial reconfiguration of grocery store produce departments.

In one embodiment, adjacent bags on a roll 410 are joined by membranes 412 that are easier to tear than the fabric of the bags (e.g., by tearing with less force than required to tear the fabric of the bag). Alternatively, the bags may be joined by other connectors, such as interference connections, perforated strips, or the like. To remove a bag, a person ensures the hook 424 is passing through the hole and pulls down on the end bag of the roll 410, creating a force on the membranes 412 (or other connectors) as the hook 424 prevents the roll from spinning around the rod 422.

FIG. 5 illustrates an embodiment of the produce bags where adjacent bags are connected by interlocking pairs of slots 512 and tabs 522. Each bag has a connector 510 at one end (e.g., the bottom) with a slot 512 and a connector 520 at the other end (e.g., the top) with a tab 522. The tab 522 passes through the slot 512 of an adjacent bag to connect the bags together. The connectors 510 and 520 may be made of card, plastic, or any other suitable material. The bags may be separated either by twisting one of the connectors so that the tab 522 passes back through the slot 512 or by applying force such that the tab 522 breaks or the slot 512 tears and becomes wider. In the embodiment shown in FIG. 5, the bags are formed as a tube. One end (e.g., the top) is open to enable produce or other items to be placed into and removed from the bag. The other end is sealed with a clip 530 made of metal, plastic, or any other suitable material.

FIG. 6 illustrates an embodiment of the produce bags where, instead of using a clip 530 to seal the bottom end of the bag, the bottom end is sealed by sewing, gluing, or otherwise fusing the front and back of the bag together. Similar to the embodiment shown in FIG. 5, a system of slots 612 and tabs 622 in connectors 610 and 620, respectively, can be used to connect adjacent bags in a roll 410. However, because the bottom end of the bag is sealed straight across, rather than being bunched up by a clip 530, wider slots 612 and tabs 622 may be used.

### ADDITIONAL CONSIDERATIONS

As used herein, any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment. Similarly, use of “a” or “an” preceding an element or component is done merely for convenience. This description should be understood to mean that one or more of the elements or components are present unless it is obvious that it is meant otherwise.

Where values are described as “approximate” or “substantially” (or their derivatives), such values should be construed as accurate +/−10% unless another meaning is apparent from the context. From example, “approximately ten” should be understood to mean “in a range from nine to eleven.”

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Upon reading this disclosure, those of skill in the art will appreciate still additional alternative structural and functional designs for a reusable bag. Thus, while particular embodiments and applications have been illustrated and described, it is to be understood that the described subject matter is not limited to the precise construction and components disclosed. The scope of protection should be limited only by the following claims.

What is claimed is:

1. A reusable shopping bag comprising:
a body made from a biodegradable fabric material, the body having a top edge that defines an opening into an interior volume of the bag; and
a pair of handles, connected to the top edge of the body, wherein each handle defines a hole arranged to receive a corresponding prong of a bag-hanging fixture that is configured to hold conventional plastic shopping bags.

2. The reusable shopping bag of claim 1, wherein the biodegradable fabric material is wood-based.

3. The reusable shopping bag of claim 1, wherein the biodegradable fabric material is knitted, and ribs of the knit run horizontally across the bag.

4. The reusable shopping bag of claim 1, wherein the biodegradable fabric material is knitted, and ribs of the knit run vertically across the bag.

5. The reusable shopping bag of claim 1, wherein the biodegradable fabric material is home-compostable.

6. The reusable shopping bag of claim 1, further comprising a tab disposed on the top edge of the body approximately midway between the pair of handles, the tab defining a hole arranged to receive a third prong of the bag-hanging fixture.

7. The reusable shopping bag of claim 6, wherein the tab is disposed on a front side of the top edge, the bag further comprising a second tab disposed on a back edge of the top surface, the second tab defining a second hole aligned with the hole and arranged to receive the third prong of the bag-hanging fixture.

8. The reusable shopping bag of claim 1, wherein each handle comprises:
a grip portion; and
a side tab, wherein the hole is defined by the side tab.

9. The reusable shopping bag of claim 1, wherein the body comprises a front piece and a substantially identical back piece that is connected to the front piece.

10. The reusable shopping bag of claim 9, wherein each handle is formed by a portion of the front piece of the body and a portion of the back piece of the body.

11. The reusable shopping bag of claim 10, wherein the hole defined by a first handle of the pair of handles in defined by the portion of the front piece of the body, and the portion of the back piece of the body defines a second hole that is aligned with the hole defined by the front piece of the body.

12. The reusable shopping bag of claim 1, wherein the biodegradable fabric material around at least a portion of the hole is reinforced with a glue-like material.

13. A produce bag comprising:
a body made from a biodegradable fabric material, the body having a top end and a bottom end;
a top connector, attached to the top end of the body; and
a bottom connector, attached to the bottom end of the body, wherein the bottom connector is configured to engage with the top connector of an additional produce bag.

14. The produce bag of claim 13, wherein the body comprises a wood-based compostable material.

15. The produce bag of claim 14, wherein the wood-based compostable material is a mesh that enables items inside the bag to be seen without opening the bag.

16. The produce bag of claim 13, wherein the produce bag and the additional produce bag are part of a roll of produce bags.

17. The produce bag of claim 16, wherein the roll of produce bags is configured to be mounted on a fixture configured to hold conventional plastic produce bags.

18. The produce bag of claim 13, further comprising a clip sealing the bottom end of the body.

19. The produce bag of claim 13, wherein the top connector comprises a tab and the bottom connector comprises a slot configured to engage with the tab.

20. The produce bag of claim 13, wherein at least one of the top connector or the bottom connector comprises a membrane that tears with less force than is required to tear the biodegradable fabric material.
